(19) United States
(12) Patent Application Publication
(10) Pub. No.: US 2003/0140276 A1
(43) Pub. Date: Jul. 24, 2003

(54) Method and apparatus for identifying clusters of fail bits in a bitmap

(76) Inventor: Arman Sagatelian, Sunnyvale, CA (US)

Correspondence Address: WILLIAM P. WILBAR, SIERRA PATENT GROUP, LTD, P.O. BOX 6149, STATELINE, NV, 89449, US

(21) Appl. No.: 10/055,086

(22) Filed: Jan. 22, 2002

(51) Int. Cl. G06F 11/00

(52) U.S. Cl. 714/25

(57) ABSTRACT

A method for identifying clusters of fail bits in a bitmap, comprises: (a) finding an available fail bit in a bitmap, and adding the available fail bit to a cluster list; (b) finding a first set of available fail bits individually within a prespecified distance from the available fail bit, and adding the first set of available fail bits to the cluster list; and (c) finding additional sets of available fail bits individually within the prespecified distance from individual of the first set or individual sets of available fail bits, and adding the additional sets of available fail bits to the cluster list so as to identify a cluster of fail bits in the bitmap. An apparatus for identifying clusters of fail bits in a bitmap comprises a memory for storing the bitmap and at least one circuit configured to perform the method.

### FIELD OF THE INVENTION

The present invention generally relates to failure analysis techniques and in particular, to a method and apparatus for identifying clusters of fail bits in a bitmap.

### BACKGROUND OF THE INVENTION

As product life cycles shorten, rapid yield improvement becomes critical. In the area of semiconductor devices, for example, a major part of the yield improvement effort has traditionally involved failure analysis on devices that fail electrical test. Once fault sources for device failures are determined, the information is fed back to the fabrication facility for corrective action.

A bitmap is a map of bits of a memory or other array type semiconductor device, that indicates the passing or failing of an electrical test by each bit in the array. By subjecting a device to multiple electrical tests, multiple bitmaps may be generated for that device. Since a cluster of fail bits (i.e., bits failing an electrical test) in a bitmap may represent a failure signature or pattern indicative of a fault source, it is useful to identify such clusters in the bitmap.

Specially trained personnel visually inspecting graphically displayed bitmaps on a computer screen conventionally perform the identification of clusters of fail bits in a bitmap. Where a large number of bitmaps are to be reviewed, however, such an approach can be laborious and time consuming. Further, its results are not readily usable by computer automated failure analysis systems such as described, for example, in U.S. Pat. No. 5,475,695, entitled “Automatic Failure Analysis System,” invented by John M. Caywood et al., which is incorporated herein by this reference.

### OBJECTS AND SUMMARY OF THE INVENTION

Accordingly, an object of the present invention is a method for identifying clusters of fail bits in a bitmap that is suitable for running on a computer.

Another object is an apparatus for identifying clusters of fail bits in a bitmap that is compatible with computer automated failure analysis systems.

These and additional objects are accomplished by the various aspects of the present invention, wherein briefly stated, one aspect is a method for identifying clusters of fail bits in a bitmap, comprising: (a) finding an available fail bit in a bitmap, and adding the available fail bit to a cluster list; (b) finding a first set of available fail bits individually within a prespecified distance from the available fail bit, and adding the first set of available fail bits to the cluster list; and (c) finding additional sets of available fail bits individually within the prespecified distance from individual of the first set or individual sets of available fail bits, and adding the additional sets of available fail bits to the cluster list so as to identify a cluster of fail bits in the bitmap.

Another aspect is an apparatus for identifying clusters of fail bits in a bitmap that includes a memory and at least one circuit. The memory stores a bitmap including fail bits. The at least one circuit is configured to: (a) find an available fail bit in the bitmap, generate a cluster list, and add the available fail bit to the cluster list; (b) find a first set of available fail bits in the bitmap that are individually within a prespecified distance from the available fail bit, and add the first set of available fail bits to the cluster list; and (c) find additional sets of available fail bits in the bitmap that are individually within the prespecified distance from individual of the first set or additional sets of available fail bits, and add the additional sets of available fail bits to the cluster list so as to identify a cluster of fail bits in the bitmap.

Still another aspect is a computer readable media storing a program for identifying clusters of fail bits in a bitmap and adapted to interact with a processor to perform the program. The stored program causes the processor to perform the functions of: (a) finding an available fail bit in a bitmap, and adding the available fail bit to a cluster list; (b) finding a first set of available fail bits individually within a prespecified distance from the available fail bit, and adding the first set of available fail bits to the cluster list; and (c) finding additional sets of available fail bits individually within the prespecified distance from individual of the first set or additional sets of available fail bits, and adding the additional sets of available fail bits to the cluster list so as to identify a cluster of fail bits in the bitmap.

Additional objects, features and advantages of the various aspects of the invention will become apparent from the following description of its preferred embodiments, which description should be taken in conjunction with the accompanying drawings.

### BRIEF DESCRIPTION OF THE DRAWINGS

FIG. 1 illustrates, as an example, a method for identifying clusters of fail bits in a bitmap, utilizing aspects of the present invention.

FIGS. 2˜5 illustrate, as examples, organizations of bits in a bitmap.

FIG. 6 illustrates, as an example, two fail bits in a bitmap employing an X-Y coordinate system.

FIG. 7 illustrates, as an example, several fail bits in a bitmap with two circles indicating prespecified distances from two of those fail bits.

FIGS. 8˜9 illustrate an example of the method for identifying clusters of fail bits in a bitmap, utilizing aspects of the present invention.

### DETAILED DESCRIPTION OF THE PREFERRED EMBODIMENT

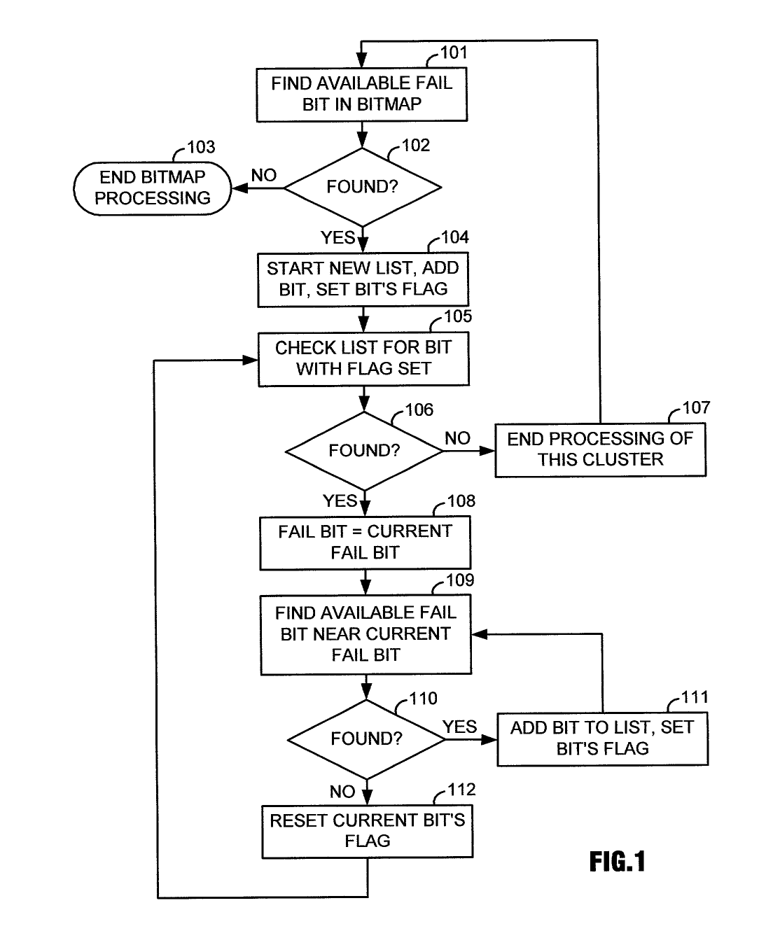

FIG. 1 illustrates a method for identifying clusters of fail bits in a bitmap. A processor programmed to perform the method along with a memory for storing the bitmap is its preferred implementation. More broadly speaking, however, at least one circuit that is configured to perform the method may be used.

In 101, the method seeks an available fail bit in a bitmap. As used herein, the term “available” means at a minimum that the fail bit has not yet been added to a cluster list (i.e., been associated with a cluster of fail bits). Additionally, its meaning may also constrain the fail bit to be within a certain region when the bitmap includes multiple regions.

In 102, a determination is then made whether an available fail bit has been found in 101. If an available fail bit has not been found, then the method proceeds to 103 to end processing of the current bitmap. On the other hand, if an available fail bit has been found, then the method proceeds to 104 to continue processing of the current bitmap.

In 104, the method continues processing of the current bitmap by starting a cluster list, adding the available fail bit found in 101 to the cluster list, and setting a flag associated with the available fail bit to indicate a first state. In 105, the method then checks the cluster list for a fail bit included therein that has an associated flag set to indicate the first state. The first time that it does this, of course, it will find the fail bit that was just added in 104. In 106, a determination is then made whether a fail bit was found in 105. If such a fail bit was not found, then the method proceeds to 107 to end processing of the current cluster list and jumps back to 101 to find another available fail bit to start a new cluster list. On the other hand, if such a fail bit was found, then the method proceeds to 108 to continue processing of the current cluster list.

In 108, the method continues processing of the current cluster list by first referring to the fail bit found in 105 as the current fail bit. In 109, the method then seeks an available fail bit that is near the current fail bit. In order to be considered “available” in this case, the fail bit must reside in a same region of the bitmap as the current fail bit (as well as not be included in the current or any other cluster list). Further, in order to be considered “near” the current fail bit, the fail bit must be within a prespecified distance from the current fail bit.

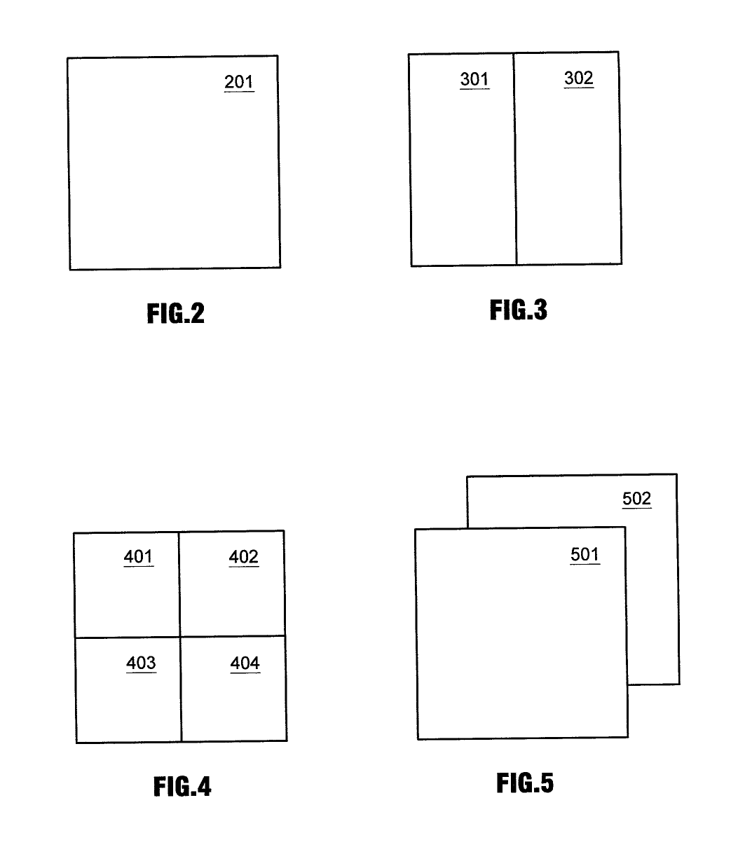

To elaborate on what is meant by regions of a bitmap, FIGS. 2˜5 illustrate four different bitmaps. FIG. 2 depicts a bitmap that is one contiguous array or region of bits 201 organized in conventional rows and columns. FIG. 3, on the other hand, depicts another bitmap that is split into two contiguous arrays or regions, 301 and 302, each referred to as a half of the bitmap. FIG. 4 depicts yet another bitmap that is split into four contiguous arrays or regions, 401˜404, each referred to as a quadrant of the bitmap. FIG. 5 depicts still another bitmap that is split into two sets of contiguous arrays or regions, 501 and 502, each referred to as a plane of the bitmap.

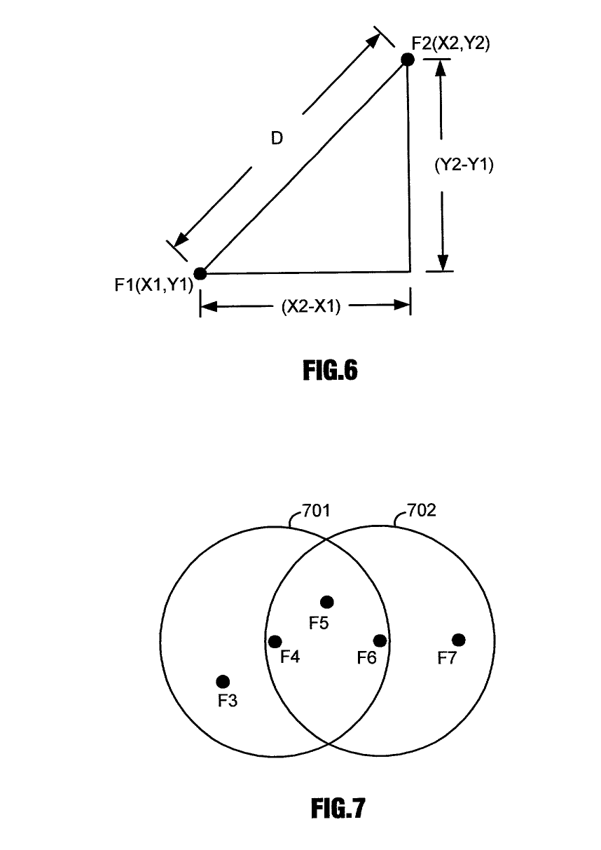

To elaborate on what is meant by a fail bit being within a prespecified distance from the current fail bit, FIGS. 6 and 7 are provided. FIG. 6 depicts a current fail bit F2 and an available fail bit F1 on a conventional X-Y coordinated bitmap. The current fail bit F2 has X-Y coordinates (X1, Y1) in this case, and the available fail bit F1 has X-Y coordinates (X2, Y2). The “prespecified distance” between F1 and F2 may then be defined in any one of several ways. For example, it may be the conventional distance D, which is equal to the square root of [(X2−X1)²+(Y2−Y1)²], or it may be a simpler computed value that is indicative of distance such as the sum of the absolute value of (X2−X1) and the absolute value of (Y2−Y1) or the larger or maximum of [absolute value of (X2−X1), absolute value of (Y2−Y1)]. The exact value of the prespecified distance may be selected by failure analysis personnel using their prior experience, educated guess, or trial-and-error techniques. FIG. 7 depicts five fail bits F3˜F7 in a bitmap with a first circle 701, as an example, indicating a prespecified distance from fail bit F4 and a second circle 702, as another example, indicating a prespecified distance from fail bit F6. Note that fail bits F3, F5 and F6 are each within the prespecified distance from F4, while fail bit F7 is not. However, fail bit F7 would still be included in the same cluster list, because it is within the prespecified distance from fail bit F6, which in turn, is within the prespecified distance from fail bit F4.

In 110, a determination is then made whether an available fail bit within the prespecified distance from the current fail bit has been found in 109. If such an available fail bit has been found, then the method proceeds to 111 to add that available fail bit to the cluster list, set a flag associated with the available fail bit to indicate the first state, and jump back to 109 to find another available fail bit near the current fail bit. On the other hand, if an available fail bit has not been found, then the method proceeds to 112 to reset the flag associated with the current fail bit to indicate a second state, and then jump back to 105 to check the cluster list for another fail bit having an associated flag that is still set to indicate the first state.

Thus, by performing the method described in reference to 101˜112, all clusters within a bitmap may be identified. To efficiently do so for bitmaps having multiple regions, the finding of available fail bits is not to be constrained to be within any particular region in performing 101, while the finding of available fail bits near the current fail bit is to be constrained to be within the same region as the current fail bit in performing 109. Selection of the prespecified distance used in 109, determines the size and density of the clusters identified by the method.

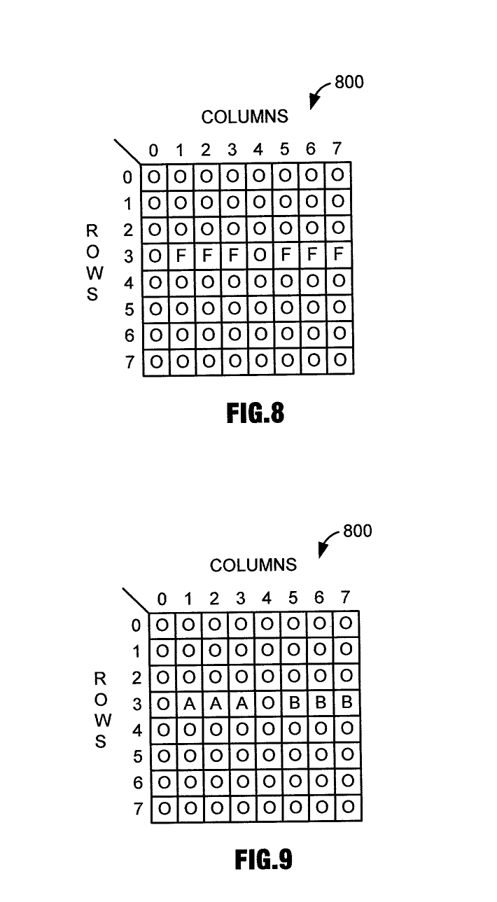

FIGS. 8˜9 illustrate an example of the method for identifying clusters of fail bits in a bitmap 800. FIG. 8 depicts a simple 8×8 bitmap having rows 0˜7 and columns 0˜7. In the figure, a “0” indicates a pass bit (i.e., a bit passing the electrical test associated with the bitmap) and an “F” indicates a fail bit (i.e., a bit failing the electrical test associated with the bitmap). FIG. 9 depicts the same bitmap 800 where fail bits (3,1), (3,2) and (3,3) are included in an identified cluster “A” and fail bits (3,5), (3,6) and (3,7) are included in another identified cluster “B” using a prespecified distance of 1. If a larger prespecified distance had been used, for example, 2, then all six fail bits would have been included in the same identified cluster.

Now applying this example to the method described in reference to FIG. 1, in 101, the method seeks an available fail bit in the bitmap 800. It performs its seeking, for example, by inspecting each bit proceeding along each row (column 0 to column 7) from the top row (row 0) to the bottom row (row 7) in a typical CRT raster scan fashion. After finding the first fail bit (3,1), it proceeds through 102 to 104, where it starts a cluster list for cluster “A”, adds the fail bit (3,1) to the cluster list “A”, and sets a flag associated with the fail bit (3,1) to indicate a first state. In 105, it checks the cluster list “A” for a fail bit included therein that has an associated flag set to indicate the first state. After finding the just added fail bit (3,1), it proceeds through 106 to 108, where it refers to the fail bit (3,1) now as the current fail bit. In 109, the method then seeks an available fail bit that is within the prespecified distance of 1 from the current fail bit. After finding the second fail bit (3,2), it proceeds through 110 to 111, where it adds the fail bit (3,2) to the cluster list “A”, sets a flag associated with the fail bit (3,2) to indicate the first state, and jumps back to 109 to seek another available fail bit that is within the prespecified distance of 1 from the current fail bit. This time, after not finding another available fail bit within the prespecified distance of 1, the method proceeds through 110 to 112, where it resets the flag associated with the current fail bit (3,1) to indicate a second state and jumps back to 105.

In 105, the method again checks the cluster list “A” for a fail bit included therein that has an associated flag set to indicate the first state. After finding the recently added fail bit (3,2), it proceeds through 106 to 108, where it refers to the fail bit (3,2) now as the current fail bit. In 109, the method then seeks an available fail bit that is within the prespecified distance of 1 from the current fail bit. After finding the third fail bit (3,3), it proceeds through 110 to 111, where it adds the fail bit (3,3) to the cluster list “A”, sets a flag associated with the fail bit (3,3) to indicate the first state, and jumps back to 109 to seek another available fail bit that is within the prespecified distance of 1 from the current fail bit. After not finding another available fail bit within the prespecified distance of 1, the method proceeds through 110 to 112, where it resets the flag associated with the current fail bit (3,2) to indicate the second state and jumps back to 105.

Back at 105, the method again checks the cluster list “A” for a fail bit included therein that has an associated flag set to indicate the first state. After finding the recently added fail bit (3,3), it proceeds through 106 to 108, where it refers to the fail bit (3,3) now as the current fail bit. In 109, the method then seeks an available fail bit that is within the prespecified distance of 1 from the current fail bit. This time it finds none since the only fail bit within the prespecified distance of 1 is fail bit (3,2), which is unavailable since it is already in the cluster list “A”. After not finding another available fail bit within the prespecified distance of 1, the method proceeds through 110 to 112, where it resets the flag associated with the current fail bit (3,3) to indicate the second state and jumps back to 105.

Again back at 105, the method checks the cluster list “A” for a fail bit included therein that has an associated flag set to indicate the first state. This time it finds none since the associated flags of fail bits (3,1), (3,2) and (3,3) have all been reset to indicate the second state. Therefore, after not finding such a fail bit, it proceeds through 106 to 107, where it ends processing of the current cluster list “A” and jumps back to 101 to look for more clusters in the bitmap 800.

Back at 101, the method seeks another available fail bit in the bitmap 800. After finding the fourth fail bit (3,5), it proceeds through 102 to 104, where it starts a new cluster list for cluster “B”, adds the fail bit (3,5) to the cluster list “B”, and sets a flag associated with the fail bit (3,5) to indicate the first state. In 105, it checks the new cluster list “B” for a fail bit included therein that has an associated flag set to indicate the first state. After finding the just added fail bit (3,5), it proceeds through 106 to 108, where it refers to the fail bit (3,5) now as the current fail bit. In 109, the method then seeks an available fail bit that is within the prespecified distance of 1 from the current fail bit. After finding the fifth fail bit (3,6), it proceeds through 110 to 111, where it adds the fail bit (3,6) to the new cluster list “B”, sets a flag associated with the fail bit (3,6) to indicate the first state, and jumps back to 109 to seek another available fail bit that is within the prespecified distance of 1 from the current fail bit. This time, after not finding another available fail bit within the prespecified distance of 1, the method proceeds through 110 to 112, where it resets the flag associated with the current fail bit (3,5) to indicate the second state and jumps back to 105.

In 105, the method again checks the new cluster list “B” for a fail bit included therein that has an associated flag set to indicate the first state. After finding the recently added fail bit (3,6), it proceeds through 106 to 108, where it refers to the fail bit (3,6) now as the current fail bit. In 109, the method then seeks an available fail bit that is within the prespecified distance of 1 from the current fail bit. After finding the sixth fail bit (3,7), it proceeds through 110 to 111, where it adds the fail bit (3,7) to the new cluster list “B”, sets a flag associated with the fail bit (3,7) to indicate the first state, and jumps back to 109 to seek another available fail bit that is within the prespecified distance of 1 from the current fail bit. After not finding another available fail bit within the prespecified distance of 1, the method proceeds through 110 to 112, where it resets the flag associated with the current fail bit (3,6) to indicate the second state and jumps back to 105.

Back at 105, the method again checks the new cluster list “B” for a fail bit included therein that has an associated flag set to indicate the first state. After finding the recently added fail bit (3,7), it proceeds through 106 to 108, where it refers to the fail bit (3,7) now as the current fail bit. In 109, the method then seeks an available fail bit that is within the prespecified distance of 1 from the current fail bit. This time it finds none. After not finding another available fail bit within the prespecified distance of 1, the method proceeds through 110 to 112, where it resets the flag associated with the current fail bit (3,7) to indicate the second state and jumps back to 105.

Again back at 105, the method checks the new cluster list “B” for a fail bit included therein that has an associated flag set to indicate the first state. This time it finds none since the associated flags of fail bits (3,5), (3,6) and (3,7) have all been reset to indicate the second state. Therefore, after not finding such a fail bit, it proceeds through 106 to 107, where it ends processing of the new cluster list “B” and jumps back to 101 to look for more clusters in the bitmap 800.

Back at 101, the method seeks another available fail bit in the bitmap 800. After finding none this time, it proceeds through 102 to 103, where it ends processing of the bitmap 800 after having identified clusters “A” and “B” as described above.

Although the various aspects of the present invention have been described with respect to a preferred embodiment, it will be understood that the invention is entitled to full protection within the full scope of the appended claims.

I claim:

1. A method for identifying clusters of fail bits in a bitmap, comprising:
(a) finding an available fail bit in a bitmap, and adding said available fail bit to a cluster list;
(b) finding a first set of available fail bits individually within a prespecified distance from said available fail bit, and adding said first set of available fail bits to said cluster list; and
(c) finding additional sets of available fail bits individually within said prespecified distance from individual of said first set of available fail bits or individual of said additional sets of available fail bits, and adding said additional sets of available fail bits to said cluster list so as to identify a cluster of fail bits in said bitmap.

2. The method according to claim 1, wherein (a) comprises finding a fail bit that has not already been added to said cluster list.

3. The method according to claim 1, wherein (b) comprises finding a first set of available fail bits that individually have not already been added to said cluster list.

4. The method according to claim 1, wherein (b) and (c) are not performed if an available fail bit cannot be found in (a).

5. The method according to claim 1, further comprising repeating (a) through (c) multiple times to identify multiple clusters of fail bits in said bitmap.

6. The method according to claim 5, wherein (a) comprises finding a fail bit that has not already been added to said cluster list.

7. The method according to claim 5, wherein (b) comprises finding a first set of available fail bits that individually have not already been added to said cluster list.

8. The method according to claim 5, wherein (c) comprises finding additional sets of available fail bits that individually have not already been added to cluster lists identifying said multiple clusters of fail bits in said bitmap.

9. The method according to claim 5, wherein processing of said bitmap is terminated if an available fail bit cannot be found in (a).

10. The method according to claim 1, wherein (b) further comprises setting a flag associated with said available fail bit to indicate a first state.

11. The method according to claim 10, wherein (b) further comprises resetting said flag so as to indicate a second state after finding all of said first set of available fail bits.

12. The method according to claim 10, wherein (b) comprises:
(b1) finding another available fail bit within said prespecified distance from said available fail bit;
(b2) if such another available fail bit is found in (b1), then adding said another available fail bit to said cluster list, and jumping back to (b1); and
(b3) if no such another available fail bit is found in (b1), then completing said finding of said first set of available fail bits and resetting said flag associated with said available fail bit to indicate said second state.

13. The method according to claim 10, wherein (c) comprises:
(c1) checking said cluster list for a fail bit added thereto and having an associated flag that is set to indicate said first state;
(c2) if no such fail bit is found in (c1), then ending processing of said cluster list and jumping back to (a) to process another cluster list; and
(c3) if such fail bit is found in (c1), then indicating said fail bit as a current fail bit;
(c4) finding another available fail bit within said prespecified distance from said current fail bit;
(c5) if such another available fail bit is found in (c4), then adding said another available fail bit to said cluster list, and jumping back to (c4); and
(c5) if no such another available fail bit is found in (c4), then resetting said flag associated with said current fail bit to indicate said second state, and jumping back to (c1).

14. The method according to claim 1, wherein said bitmap is organized by X-Y coordinates, and said prespecified distance is measured by a square root of [(X2−X1)²+(Y2−Y1)²], where X1 and Y1 are coordinates associated with said available fail bit and X2 and Y2 are coordinates associated with individual of said first set of available fail bits.

15. The method according to claim 1, wherein said bitmap is organized by X-Y coordinates, and said prespecified distance is measured by a sum of abs(X2−X1) and abs(Y2−Y1), where abs indicates absolute value, X1 and Y1 are coordinates associated with said available fail bit, and X2 and Y2 are coordinates associated with individual of said first set of available fail bits.

16. The method according to claim 1, wherein said bitmap is organized by X-Y coordinates, and said prespecified distance is measured by a larger or maximum of [abs(X2−X1), abs(Y2−Y1)], where abs indicates absolute value, X1 and Y1 are coordinates associated with said available fail bit, and X2 and Y2 are coordinates associated with individual of said first set of available fail bits.

17. The method according to claim 1, wherein said first set of available fail bits and said additional sets of available fail bits are constrained to be within a same region of said bitmap as said available fail bit is found.

18. The method according to claim 17, wherein said same region is a half of said bitmap.

19. The method according to claim 17, wherein said same region is a quadrant of said bitmap.

20. An apparatus for identifying clusters of fail bits in a bitmap, comprising:
a memory storing fail bits in a bitmap; and
at least one circuit configured to
(a) find an available fail bit in said bitmap, generate a cluster list, and add said available fail bit to said cluster list;
(b) find a first set of available fail bits in said bitmap that are individually within a prespecified distance from said available fail bit, and add said first set of available fail bits to said cluster list; and
(c) find additional sets of available fail bits in said bitmap that are individually within said prespecified distance from individual of said first set of available fail bits or individual of said additional sets of available fail bits, and add said additional sets of available fail bits to said cluster list so as to identify a cluster of fail bits in said bitmap.

21. The apparatus according to claim 20, wherein said at least one circuit is further configured to repeat functions (a) through (c) multiple times to identify multiple clusters of fail bits in said bitmap.

22. The apparatus according to claim 20, wherein said at least one circuit comprises a processor programmed to perform functions (a) through (c).

23. A computer readable media storing a program for identifying clusters of fail bits in a bitmap and adapted to interact with a processor to perform said program, wherein said program causes said processor to perform the functions of:
(a) finding an available fail bit in a bitmap, and adding said available fail bit to a cluster list;
(b) finding a first set of available fail bits individually within a prespecified distance from said available fail bit, and adding said first set of available fail bits to said cluster list; and
(c) finding additional sets of available fail bits individually within said prespecified distance from individual of said first set of available fail bits or individual of said additional sets of available fail bits, and adding said additional sets of available fail bits to said cluster list so as to identify a cluster of fail bits in said bitmap.
